(19) United States
(12) Patent Application Publication
(10) Pub. No.: US 2013/0032394 A1
(43) Pub. Date: Feb. 7, 2013

(54) ANTICORROSIVE, COATED ELECTRIC WIRE WITH TERMINAL, AND WIRING HARNESS

(71) Applicants: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Tsubasa Nishida, Yokkaichi-shi (JP); Kazuo Nakashima, Yokkaichi-shi (JP); Hideki Imamura, Yokkaichi-shi (JP)

(72) Inventors: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Tsubasa Nishida, Yokkaichi-shi (JP); Kazuo Nakashima, Yokkaichi-shi (JP); Hideki Imamura, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/581,132

(22) PCT Filed: Mar. 1, 2011
(86) PCT No.: PCT/JP2011/054591

§ 371 Date: Sep. 19, 2012

(30) Foreign Application Priority Data
Mar. 4, 2010 (JP) 2010-047353

(51) Int. Cl. H01B 5/02; C09D 163/00

(52) U.S. Cl. 174/74 R; 523/400

(57) ABSTRACT

An anticorrosive that is capable of delivering high anticorrosive capability. The anticorrosive mainly contains an epoxy resin, and has a viscosity within a range of 1000 to 30000 mPa·s at 25 degrees C., which is measured in accordance with the JIS Z8803. The anticorrosive can be favorably applied to an electrically connected portion between a wire conductor of a coated electric wire with a terminal and a terminal member. The coated electric wire with the terminal has the configuration that the electrically connected portion between the wire conductor and the terminal member is coated with a cured material of the anticorrosive. The epoxy resin is preferably a one-component epoxy resin.

### TECHNICAL FIELD

The present invention relates to an anticorrosive, a coated electric wire with a terminal, and a wiring harness, and more specifically relates to an anticorrosive that is favorably used to prevent corrosion from building up at an electrically connected portion between a wire conductor and a terminal member, a coated electric wire with a terminal using the anticorrosive, and a wiring harness using the anticorrosive.

### BACKGROUND ART

Conventionally, a coated electric wire, which is prepared by coating a wire conductor made of an annealed wire such as tough pitch copper with an insulation, is in widespread use as an electric wire used for wiring in a car such as an automobile. A terminal member is connected to the wire conductor at an end of the coated electric wire, where the wire conductor is exposed by stripping off the insulation. The terminal member that is electrically connected to the end of the coated electric wire is inserted and locked into a connector.

A plurality of the coated electric wires with the terminals are bunched into a wiring harness. The coated electric wires in the form of wiring harness are used for wiring in a car such as an automobile.

Used for wiring in an engine room or a certain indoor environment that is subject to water, the wiring harness is susceptible to heat and water, so that rust is liable to form at electrically connected portions between the wire conductors and the terminal members. For this reason, it is necessary to prevent corrosion from building up at the electrically connected portions when the wiring harness is used in this environment.

In order to prevent corrosion from building up at the electrically connected portions, PTL 1 discloses a technique to fill with grease the connectors into which the terminal members connected to the wire conductors are inserted and locked.

### CITATION LIST

### Patent Literature

PTL1: JP H05-159846A

### SUMMARY OF INVENTION

### Technical Problem

These days, there are increasing tendencies to improve fuel efficiency of an automobile by weight reduction of a car, and accordingly weight reduction of material for the electric wires that make up the wiring harness is demanded. For this reason, using aluminum for the wire conductors is considered.

Copper or a copper alloy that has excellent electric properties is generally used for the terminal members, and accordingly the aluminum electric wires and the copper terminal members are used in combination. However, when the wire conductors are different in material from the terminal members, bimetallic corrosion builds up at the electrically connected portions. This kind of corrosion builds up more easily compared with the case of using a same material for the wire conductors and the terminal members. For this reason, an anticorrosive is required, which can prevent corrosion from building up at the electrically connected portions in a convincing way.

However, the conventional grease is not capable of sufficiently preventing water immersion if it is not filled densely in the connectors. If the amount of grease filling is increased in order to enhance the anticorrosion effect, the grease is unintentionally coated on a portion where corrosion prevention is not required. In addition, excessive filling makes the connectors and the electric wires sticky, which decreases handleability. For this reason, an anticorrosive that is capable of delivering high anticorrosive capability that can be replaced with the problematic grease is demanded.

An object of the present invention is to provide an anticorrosive that is capable of delivering high anticorrosive capability. Other objects are to provide a coated electric wire with a terminal using the anticorrosive, and to provide a wiring harness using the anticorrosive.

### Solution to Problem

In order to solve the problems described above, the anticorrosive of the present invention mainly contains an epoxy resin, and has a viscosity within a range of 1000 to 30000 mPa·s at 25 degrees C., which is measured in accordance with the JIS Z8803.

It is preferable that the anticorrosive is used at an electrically connected portion between a wire conductor and a terminal member.

It is preferable that the epoxy resin defines a one-component epoxy resin.

In another aspect of the present invention, a coated electric wire with a terminal includes a wire conductor and a terminal member, wherein an electrically connected portion between the wire conductor and the terminal member is coated with a cured material of the anticorrosive.

It is preferable that in the coated electric wire with the terminal, the wire conductor includes elemental wires made of aluminum or an aluminum alloy, and the terminal member is made of copper or a copper alloy.

Yet, in another aspect of the present invention, a wiring harness includes the coated electric wire with the terminal.

### ADVANTAGEOUS EFFECTS OF INVENTION

Mainly containing the epoxy resin, and having the viscosity at 25 degrees C. within the range of 1000 to 30000 mPa·s, which is measured in accordance with the JIS Z8803, the anticorrosive of the present invention has an excellent coating property compared with grease, and is capable of delivering excellent anticorrosive capability after curing. In addition, mainly containing the epoxy resin, the anticorrosive of the present invention has an excellent heat resistance after curing.

If the anticorrosive is used at the electrically connected portion between the wire conductor and the terminal member, the electrically connected portion has improved anticorrosive capability, which allows the electrically connected portion to have increased connecting reliability.

If the one-component epoxy resin is used as the epoxy resin, a mixing process is unnecessary unlike the two-component epoxy resin, which can contribute to improvement in productivity when the anticorrosive is used at the electrically connected portion between the wire conductor and the terminal member.

Having the configuration that the electrically connected portion between the wire conductor and the terminal member is coated with the anticorrosive, the coated electric wire with the terminal of the present invention has the electrically connected portion that has improved anticorrosive capability, which allows the electrically connected portion to have increased connecting reliability.

If the wire conductor includes the elemental wires made of aluminum or an aluminum alloy and the terminal member is made of copper or a copper alloy, which establishes bimetallic connection, full use of the effect of the anticorrosive of the present invention can be made.

The wiring harness of the present invention includes the coated electric wire with the terminal that has improved anticorrosive capability. Thus, the wiring harness can be used favorably for wiring in an engine room or a certain indoor environment that is subject to water.

### BRIEF DESCRIPTION OF DRAWINGS

FIG. 1 is a view showing a coated electric wire with a terminal of a first preferred embodiment of the present invention.

FIG. 2 is a cross-sectional view along the line A-A of FIG. 1.

FIG. 3 is a view for illustrating a corrosion test.

### DESCRIPTION OF EMBODIMENTS

Detailed descriptions of an anticorrosive of preferred embodiments of the present invention (hereinafter, referred to also as the “present anticorrosive”), a coated electric wire with a terminal of preferred embodiments of the present invention (hereinafter, referred to also as the “present coated electric wire”), and a wiring harness of preferred embodiments of the present invention (hereinafter, referred to also as the “present wiring harness”) will now be provided.

1. Present Anticorrosive

The present anticorrosive mainly contains an epoxy resin. The epoxy resin may define a one-component epoxy resin or a two-component epoxy resin. If the one-component epoxy resin is used as the epoxy resin, a mixing process is unnecessary unlike the two-component epoxy resin, which can contribute to improvement in productivity when the anticorrosive is used at an electrically connected portion between a wire conductor and a terminal member.

Examples of the epoxy resin include a bisphenol A epoxy resin, a bisphenol F epoxy resin and a bisphenol AD epoxy resin that are made of phenols, an aliphatic epoxy resin made of alcohols, an epoxy resin made of amines, and a cresol novolac epoxy resin made of o-cresol novolac resin.

The present anticorrosive may consist of one epoxy resin alone, or may consist of two or more kinds of epoxy resins. Further, the present anticorrosive may contain additives and other polymers as appropriate within a range of not impairing physical properties of the present anticorrosive.

A general additive used for a material for resin molding is used as the additive, which is not limited specifically. Specific examples of the additive include a curing agent, an inorganic filler, an antioxidant, a metal deactivator (a copper inhibitor), an ultraviolet absorber, an ultraviolet-concealing agent, a flame-retardant auxiliary agent, a processing aid (e.g., a lubricant, wax), carbon and other coloring pigments, a flexibilizer, an agent providing shock resistance, an organic filler, a dilution agent (e.g., a solvent), a thixotropic agent, coupling agents of various kinds, a defoamer, and a levelling agent.

The present anticorrosive is an uncured material, and is cured after applied to the electrically connected portion in order to increase mechanical strength of the portion. A curing method is not limited specifically. Examples of the curing method include a moisture curing method, a thermal curing method and a chemical curing method.

The present anticorrosive has a viscosity within a range of 1000 to 30000 mPa·s at 25 degrees C., which is measured in accordance with the JIS 28803. A rotating viscometer is preferably used as a viscometer in the measurement.

If the viscosity is less than 1000 mPa·s, the material flows out when applied, which makes it difficult to provide a sufficient amount of the anticorrosive on a portion where an anticorrosion property is required. Thus, the anticorrosive cannot easily achieve an enhanced anticorrosive effect. The lower limit of the viscosity is preferably 1500 mPa·s. On the other hand, if the viscosity is more than 30000 mPa·s, the material does not flow when applied, which makes it difficult to provide a sufficient amount of the anticorrosive on the portion where an anticorrosion property is required. Thus, the anticorrosive cannot easily achieve an enhanced anticorrosive effect. The upper limit of the viscosity is preferably 25000 mPa·s from the viewpoint of productivity and anticorrosive capability.

For example, the present anticorrosive is favorably used to prevent corrosion from building up at an electrically connected portion between a conductor of a coated electric wire and a terminal member that are used for wiring in a car such as an automobile.

2. Present Coated Electric Wire

Next, a description of the present coated electric wire is provided.

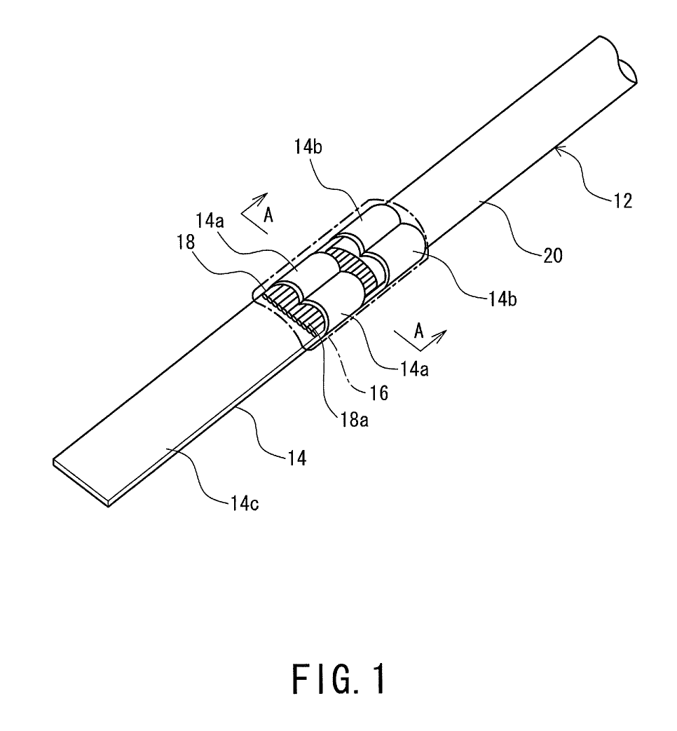

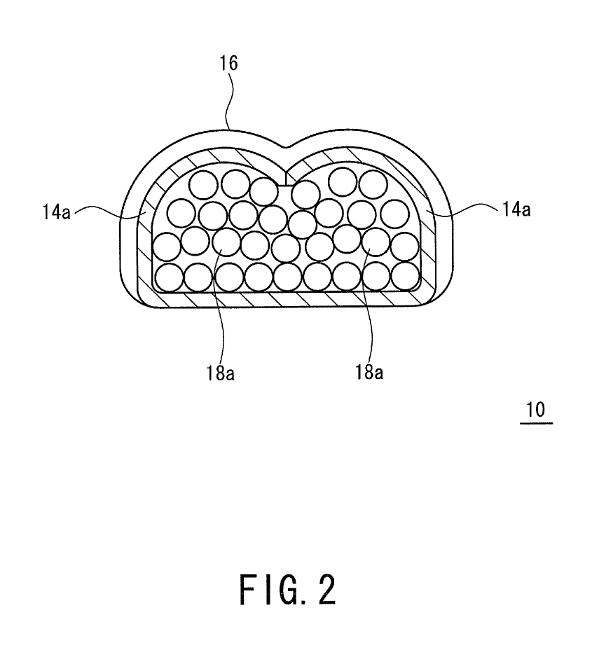

A present coated electric wire 10 includes a coated electric wire 12 including a wire conductor 18 and an insulation 20 with which the wire conductor 18 is coated, and a terminal member 14 connected to an end of the wire conductor 18 of the coated electric wire 12, as shown in FIGS. 1 and 2.

The insulation 20 is peeled off at the end of the coated electric wire 12, so that the wire conductor 18 is exposed at the end. The terminal member 14 is connected to the exposed end of the wire conductor 18. The wire conductor 18 defines a strand made up of a plurality of elemental wires 18a. In this case, the strand may be made up of metallic elemental wires of one kind, or may be made up of metallic elemental wires of two or more than two kinds. The strand may include an elemental wire made of an organic fiber in addition to the metallic elemental wires. It is to be noted that the metallic elemental wires of one kind define that all the metallic elemental wires of the strand are made of a same metallic material, and the metallic elemental wires of two or more than two kinds define that the metallic elemental wires made of different metallic materials are included in the strand. The strand may include also a reinforcement wire (tension member) for reinforcing the coated electric wire.

The metallic elemental wires are made preferably of copper, a copper alloy, aluminum or an aluminum alloy, and the elemental wires made of these materials are preferably plated. An elemental wire that is defined as the reinforcement wire is made preferably of a copper alloy, titanium, tungsten or stainless steel. An elemental wire that is defined as the organic fiber is made preferably of KEVLAR.

The insulation 20 is made preferably from rubber, polyolefin, PVC or a thermoplastic elastomer, which may be used singly or in combination. The insulation 20 may contain a variety of additives such as a flame retardant, a filler, and a coloring agent, as appropriate.

The terminal member 14 includes a connecting portion 14c having the shape of a tab and arranged to be connected to a counterpart terminal, wire barrels 14a extending from a base end of the connecting portion 14c and arranged to be crimped onto the end of the wire conductor 18 of the electric wire 12, and insulation barrels 14b extending from the wire barrels 14a and arranged to be crimped onto the insulation 20 at the end of the coated electric wire 12.

The terminal member 14 (a base member thereof) is made preferably of general brass, a variety of copper alloys or copper. It is preferable to plate a partial surface (e.g., a connecting point) or an entire surface of the terminal member 14 with a variety of metals such as tin, nickel and gold.

A portion of the wire conductor 18 is exposed at an electrically connected portion between the wire conductor 18 and the terminal member 14. In the present coated electric wire 10, the exposed portion is coated with the anticorrosive described above. To be specific, a coating film 16 of the anticorrosive lies over from the base end of the connecting portion 14c of the terminal member 14 while striding over the border between the base end of the connecting portion 14c of the terminal member 14 and the end of the wire conductor 18 until the insulation 20 while striding over the border between the insulation barrels 14b of the terminal member 14 and the insulation 20.

The anticorrosive to be used has the physical properties within the range described above, considering the combination of the material of the wire conductor 18 and the material of the terminal member 14. The thickness of the coating film 16 of the anticorrosive is adjusted as appropriate; however, the thickness is preferably from 0.01 mm to 0.1 mm. If the thickness of the coating film 16 is too large, it is difficult for the terminal member 14 to be inserted into a connector. On the other hand, if the thickness of the coating film 16 is too small, the anticorrosion effect is liable to be lessened.

After crimping the terminal member 14 onto the end of the coated electric wire 12 to connect the wire conductor 18 and the terminal member 14, the anticorrosive is coated on a surface of the connected portion between the wire conductor 18 and the terminal member 14, that is, a surface at the end of the insulation 20, surfaces of the insulation barrels 14b, surfaces of the wire barrels 14a, a surface of the exposed wire conductor 18, and a surface of the base end of the connecting portion 14c. Thus, the coating film 16 is formed on the surface of the connected portion between the wire conductor 18 and the terminal member 14.

It is also preferable to form a coating film 16 on a back surface of the tab-shaped connecting portion 14c extending from the wire barrels 14a of the terminal member 14, back surfaces of the wire barrels 14a, and back surfaces of the insulation barrels 14b if the formed coating film 16 does not impair the electrical connection.

Application of the anticorrosive is performed preferably in a falling-drop method, a coating method, or an extrusion method. It is preferable to heat or cool the anticorrosive as appropriate.

The coating film 16 of the anticorrosive is cured after applied to the electrically connected portion in order to increase mechanical strength of the portion. A curing method is not limited specifically. Examples of the curing method include a moisture curing method, a thermal curing method and a chemical curing method.

Being cured after the application, the anticorrosive is not sticky at the time of handling, and can be fixed to the applied site over a long period of time. Thus, the anticorrosion effect can be sustained over a long period of time.

3. Present Wiring Harness

A plurality of coated electric wires with terminals including the present coated electric wire 10 are bunched into the present wiring harness. In the present wiring harness, some of the included coated electric wires may be the present coated electric wires 10, or all of the included coated electric wires may be the present coated electric wires 10.

In the present wiring harness, the coated electric wires may be bound with tape, or may be armored with an armoring member such as a circular tube, a corrugated tube and a protector.

The present wiring harness is favorably used for wiring in a car such as an automobile, especially for wiring in an engine room or the interior of a car that is subject to water. These sites are susceptible to heat and water, so that when the present wiring harness is used for wiring in these sites, rust is liable to form at the electrically connected portion between the wire conductor 18 and the terminal member 14. However, using the present wiring harness can effectively prevent rust from forming at the electrically connected portion between the wire conductor 18 and the terminal member 14.

### Example

A detailed description of the present invention will now be provided with reference to Examples. It is to be noted that the present invention is not limited to Examples.

1. Preparation of Coated Electric Wires

A polyvinyl chloride composition was prepared as follows: 100 parts by mass of polyvinyl chloride (polymerization degree of 1300) was mixed with 40 parts by mass of diisononyl phthalate that defined a plasticizer, 20 parts by mass of calcium carbonate heavy that defined a filler, and 5 parts by mass of a calcium-zinc stabilizer that defined a stabilizer at 180 degrees C. in an open roll, and the mixture was formed into pellets with the use of pelletizer.

Then, a conductor (having a cross-sectional area of 0.75 mm) that defined an aluminum alloy strand that was made up of seven aluminum alloy wires was extrusion-coated with the polyvinyl chloride composition prepared as above such that the coat had a thickness of 0.28 mm. In this manner, a plurality of coated electric wires (PVC electric wires) were prepared.

2. Preparation of Coated Electric Wires with Terminals

In each of the coated electric wires prepared as above, the coat was peeled off at its end to expose the wire conductor, and then a male crimping terminal member (0.64 mm in width at a tab) made of brass generally used for automobile was crimped onto the end of each coated electric wire.

Then, anticorrosives of different kinds to be described later were each applied to electrically connected portions between the wire conductors and the terminal members of the coated electric wires, and thus the exposed wire conductors and barrels of the terminal members were coated with the anticorrosives. Then, the anticorrosives were subjected to curing treatment for the duration of respective times under the respective curing conditions in a constant temperature bath, whereby the coated electric wires with the terminals were prepared. The anticorrosives of different kinds were applied so as to be 0.05 mm in thickness.

### Example 1

One-component epoxy resin (A) [manuf.: THREEBOND CO., LTD., trade name: “2212C”, viscosity at 25 degrees C.: 25000 mPa·s, curing conditions: 80 degrees C. for 30 minutes]

### Example 2

One-component epoxy resin (B) [manuf.: THREEBOND CO., LTD., trade name: “2212”, viscosity at 25 degrees C.: 13000 mPa·s, curing conditions: 90 degrees C. for 30 minutes]

### Example 3

One-component epoxy resin (C) [manuf.: THREEBOND CO., LTD., trade name: “2210”, viscosity at 25 degrees C.: 8000 mPa·s, curing conditions: 90 degrees C. for 30 minutes]

### Example 4

One-component epoxy resin (D) [manuf.: AJINOMOTO FINE-TECHNO CO., INC., trade name: “PLENSET AE-400”, viscosity at 25 degrees C.: 10000 mPa·s, curing conditions: 80 degrees C. for 30 minutes]

### Example 5

One-component epoxy resin (E) [manuf.: AJINOMOTO FINE-TECHNO CO., INC., trade name: “PLENSET AE-15”, viscosity at 25 degrees C.: 2000 mPa·s, curing conditions: 80 degrees C. for 30 minutes]

### Example 6

Two-component epoxy resin (F) [manuf.: TAOKA CHEMICAL CO., LTD., trade name: “TECHNODYNE AH6021W”, viscosity at 25 degrees C.: 15000 mPa·s, curing conditions: 80 degrees C. for 60 minutes]

### Comparative Example 1

One-component epoxy resin (a) [manuf.: THREEBOND CO., LTD., trade name: “2212E”, viscosity at 25 degrees C.: 35000 mPa·s, curing conditions: 90 degrees C. for 30 minutes]

### Comparative Example 2

One-component epoxy resin (b) [manuf.: AJINOMOTO FINE-TECHNO CO., INC., trade name: “PLENSET AE-901B”, viscosity at 25 degrees C.: 60000 mPa·s, curing conditions: 60 degrees C. for 30 minutes]

### Comparative Example 3

Two-component epoxy resin (c) [manuf.: TAOKA CHEMICAL CO., LTD., trade name: “TECHNODYNE AH3051K”, viscosity at 25 degrees C.: 35000 mPa·s, curing conditions: 100 degrees C. for 30 minutes]

3. Evaluation Procedure

Evaluations of peeling and anticorrosive capability of the anticorrosives were performed as follows on the coated electric wires with the terminals that were coated with the anticorrosives of different kinds.

(Peeling Test)

The anticorrosives that were applied and cured were scratched by a finger nail, and the anticorrosives that were not peeled off were evaluated as PASSED, and an anticorrosive that was peeled off was evaluated as FAILED. It is to be noted that an anticorrosive, if peeled off, is obviously inferior in anticorrosive capability. For this reason, this test was performed prior to the following evaluations of anticorrosive capability.

(Anticorrosive Capability)

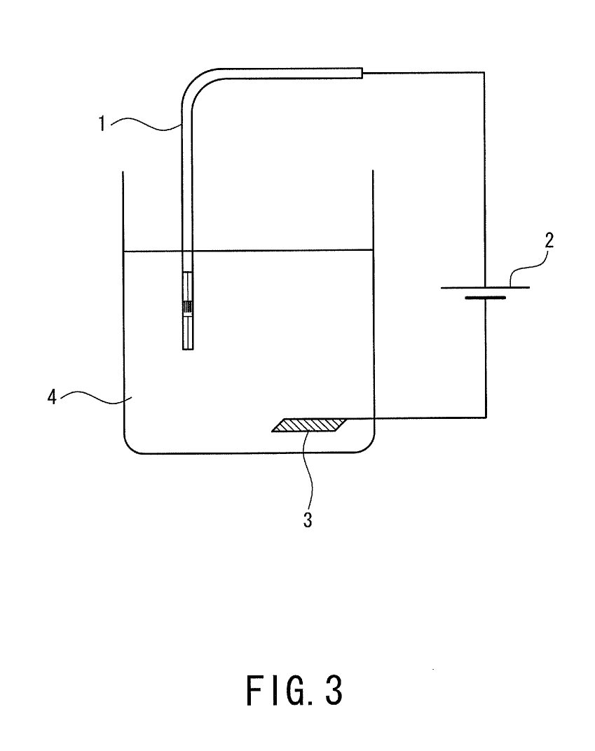

As shown in FIG. 3, each of the prepared coated electric wires 1 with the terminals was connected to a positive electrode of an electrical power source 2 of 12 volts, while a pure copper plate 3 (1 cm in width×2 cm in length×1 mm in thickness) was connected to a negative electrode of the electrical power source 2 of 12 volts. The pure copper plate 3 and each of the electrically connected portions between the wire conductors of the coated electric wires 1 and the terminal members were immersed in 300 cc of a water solution 4 containing 5% of NaCl, and a voltage of 12 volts was applied thereto for two minutes. After the application of the voltage, ICP emission analysis of the water solution 4 was performed to measure the amounts of aluminum ions eluted from the wire conductors of the coated electric wires 1 with the terminals. The coated electric wires with the terminals in which the amounts of aluminum ions eluted from the wire conductors were less than 0.1 ppm were evaluated as PASSED. The coated electric wires with the terminals in which the amounts of aluminum ions eluted from the wire conductors were 0.1 ppm or more were evaluated as FAILED.

Table 1 shows the viscosities at 25 degrees C., which were measured in accordance with the JIS 28803, and evaluation results of the anticorrosives of Examples and Comparative Examples.

TABLE 1

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Viscosity (mPa · s) | 25,000 | 13,000 | 8,000 | 10,000 | 2,000 | 15,000 | 35,000 | 60,000 | 35,000 |
| Peeling | PASSED | PASSED | PASSED | PASSED | PASSED | PASSED | PASSED | PASSED | PASSED |
| Anticorrosive | PASSED | PASSED | PASSED | PASSED | PASSED | PASSED | FAILED | FAILED | FAILED |
| Capability | | | | | | | | | |

Table 1 shows the followings. The anticorrosives of Comparative Examples are inferior in anticorrosive capability. This is because the anticorrosives of Comparative Examples have the viscosities that are out of the range specified by the present invention. It is assumed that sufficient anticorrosive capability could not be achieved because the anticorrosives did not sufficiently enter into the electrically connected portions while the anticorrosives were in close contact with electrically connected portions without being peeled off therefrom.

Meanwhile, the anticorrosives of present Examples have the viscosities that are within the range specified by the present invention. Thus, they were in sufficiently close contact with the electrically connected portions, and thus excellent anticorrosive capability could be achieved. It is assumed that because the anticorrosives had the viscosities that were within the specified range, they could sufficiently enter into the electric connected portions.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, described in the embodiments described above is the coated electric wire 10 with the terminal having the configuration of including the male terminal that includes the tab-shaped connecting portion 14c, which is defined as the terminal member 14; however, the present invention is not limited to this configuration. It is also preferable that a female terminal capable of fitting into a male terminal, or a tuning-fork terminal is used as the terminal member 14. In addition, it is also preferable that the terminal member 14 does not include the insulation barrels 14b, and the crimp is performed only by the wire barrels 14a. In addition, the method for connecting the wire conductor 12 and the terminal member 14 is not limited to the crimp using the barrels, and it is also preferable that the wire conductor 12 and the terminal member 14 are connected by a method such as pressure-resistance welding, ultrasonic welding and soldering. In addition, though the conductor 18 defines a strand in the preferred embodiments, it is preferable that the conductor 18 defines a single wire.

1-6. (canceled)

7. An anticorrosive that mainly contains an epoxy resin, and has a viscosity within a range of 1000 to 30000 mPa·s at 25 degrees C., which is measured in accordance with the JIS Z8803.

8. The anticorrosive according to claim 7, which is used at an electrically connected portion between a conductor of an electric wire and a terminal member.

9. The anticorrosive according to claim 8, wherein the epoxy resin comprises a one-component epoxy resin.

10. A coated electric wire with a terminal, the electric wire comprising a wire conductor and a terminal member, wherein an electrically connected portion between the wire conductor and the terminal member is coated with a cured material of the anticorrosive according to claim 9.

11. The coated electric wire with the terminal according to claim 10, wherein the wire conductor comprises elemental wires made of aluminum or an aluminum alloy, and the terminal member is made of copper or a copper alloy.

12. A wiring harness comprising the coated electric wire with the terminal according to claim 11.

13. A wiring harness comprising the coated electric wire with the terminal according to claim 10.

14. A coated electric wire with a terminal, the electric wire comprising a wire conductor and a terminal member, wherein an electrically connected portion between the wire conductor and the terminal member is coated with a cured material of the anticorrosive according to claim 8.

15. The coated electric wire with the terminal according to claim 14, wherein the wire conductor comprises elemental wires made of aluminum or an aluminum alloy, and the terminal member is made of copper or a copper alloy.

16. A wiring harness comprising the coated electric wire with the terminal according to claim 15.

17. A wiring harness comprising the coated electric wire with the terminal according to claim 14.

18. The anticorrosive according to claim 7, wherein the epoxy resin comprises a one-component epoxy resin.

19. A coated electric wire with a terminal, the electric wire comprising a wire conductor and a terminal member, wherein an electrically connected portion between the wire conductor and the terminal member is coated with a cured material of the anticorrosive according to claim 18.

20. The coated electric wire with the terminal according to claim 19, wherein the wire conductor comprises elemental wires made of aluminum or an aluminum alloy, and the terminal member is made of copper or a copper alloy.

21. A wiring harness comprising the coated electric wire with the terminal according to claim 20.

22. A wiring harness comprising the coated electric wire with the terminal according to claim 19.

23. A coated electric wire with a terminal, the electric wire comprising a wire conductor and a terminal member, wherein an electrically connected portion between the wire conductor and the terminal member is coated with a cured material of the anticorrosive according to claim 7.

24. The coated electric wire with the terminal according to claim 23, wherein the wire conductor comprises elemental wires made of aluminum or an aluminum alloy, and the terminal member is made of copper or a copper alloy.

25. A wiring harness comprising the coated electric wire with the terminal according to claim 24.

26. A wiring harness comprising the coated electric wire with the terminal according to claim 23.
